(19) United States
(12) Patent Application Publication
(10) Pub. No.: US 2002/0136002 A1
(43) Pub. Date: Sep. 26, 2002

(54) Wall mounted light fixture with independent main light and night light

(76) Inventor: Victor Hoernig, Lowelll, IN (US)

Correspondence Address: Edgar A. Zarins, Masco Corporation, 21001 Van Born Road, Taylor, MI, 48180, US

(21) Appl. No.: 10/066,844

(22) Filed: Feb. 4, 2002

Related U.S. Application Data
(60) Provisional application No. 60/277,604, filed on Mar. 21, 2001.

(51) Int. Cl. F21S 13/02

(52) U.S. Cl. 362/147; 362/234; 362/253; 362/432; 362/802; 362/240; 362/251; 362/294; 362/276

(57) ABSTRACT

A wall mounted light fixture intended for use in a bath area and selectively operable by a wall switch. The light fixture includes an escutcheon for concealing the wiring and a support arm extending outwardly from the escutcheon. Mounted to the support arm are independent lights including a main light to illuminate a room for typical use and a night light for low wattage illumination such as at night. The lights are mounted in vertical alignment with the main light disposed above the night light and independently operable. The fixture circuitry facilitates use of both lights simultaneously, the main light alone or the night light alone.

### RELATED APPLICATIONS

This application claims priority from U.S. Provisional Application No. 60/277,604 filed on Mar. 21, 2001.

### BACKGROUND OF THE INVENTION

I. Field of the Invention

This invention relates to wall-mounted lights and, in particular, to a single light fixture which incorporates physically and operationally independent main light and reduced wattage night light.

II. Description of the Prior Art

Reduced brightness lighting has been used extensively for safety, security and comfort. These reduced wattage lights, or night lights, allow homeowners to view their surroundings without the need to turn on regular lighting which can be blinding and may wake sleeping individuals. Many times, these night lights are left on at night to illuminate a bathroom. Typical nightlights are plugged into a wall socket and include a switch while the regular lights are operated by a wall switch. However, these night lights occupy wall plugs which can be of great demand in a bathroom.

### SUMMARY OF THE PRESENT INVENTION

The present invention overcomes the disadvantages of the prior known light assemblies by providing a single fixture which includes independently operable main light and night light.

The present invention is directed to a wall-mounted light fixture which includes a main light utilizing a standard light bulb and a night light utilizing a reduced wattage bulb. The lights utilize independent wiring circuits for individual control by independent light switches. In a preferred embodiment of the present invention, the main light is disposed above the night light which depends downwardly from a support arm. The wiring for the lights travels through the support arm. The support arm is connected to a wall escutcheon used to conceal the wiring box within the wall.

The light fixture can be operated with the main light alone, the night light alone or both lights simultaneously for a lamplighter effect. The night light depends downwardly in order to better illuminate any walking path at night. The light fixture includes independent light switches connected to the individual lights for independent control.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like pats throughout the views and in which:

FIG. 1 is a perspective view of a wall mounted light fixture embodying the present invention;

FIG. 2 is a front elevational view thereof; and

FIG. 3 is a side view of the light fixture.

### DETAILED DESCRIPTION OF A PREFERRED EMBODIMENT OF THE PRESENT INVENTION

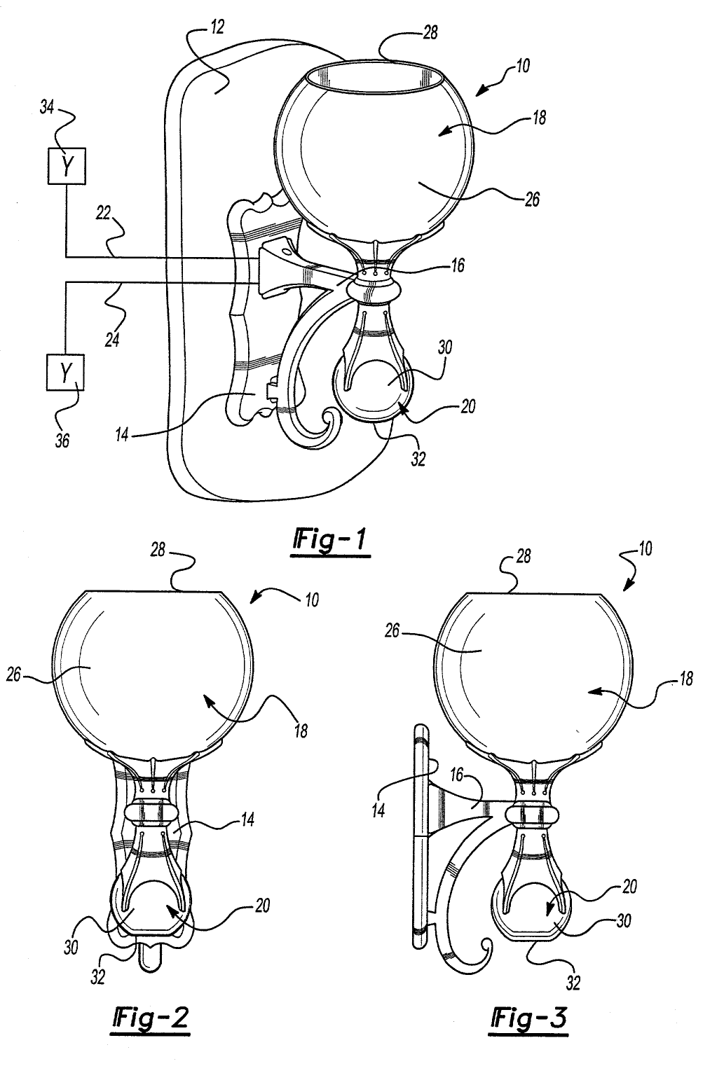

Referring to FIGS. 1 through 3, there is shown a light fixture 10 for illuminating a room or similar living space to provide safe and comfortable movement through the space. The light fixture 10 is preferably adapted to be mounted to a wall 12 in conjunction with a wall box (not shown) disposed within the wall 12. As is well known, the wall box will be mounted within the wall 12 with its opening flush with the wall 12 for retaining and ultimately concealing wires designed to selectively deliver electrical power to the light fixture 10. The light fixture 10 may be mounted directly to the wall 12 or secured to the wall base.

A preferred embodiment of the light fixture 10 includes a wall plate or escutcheon 14 for securing the fixture 10 the wall 12. The escutcheon 14 may be decorative in nature or a simple plate to cover the wall box having the electrical wiring. Extending outwardly from the escutcheon 14 is a support arm 16 to which are attached the independent lights embodying the present invention. The support arm 16 may be a variety of decorative configurations but must include a passageway for running electrical wiring to the lights.

Mounted to the support arm 16 are a main light 18 and a night light 20 for independent operation in response to independent circuitry 22, 24 respectively. In one embodiment of the present invention, the main light 18 and night light 20 are disposed in vertical alignment with one of the lights above the other light. Preferably, as shown in the drawing, the main light 18 is disposed above the night light 20 on opposite sides of the support arm 16. The main light 18 includes a decorative globe 26 having an opening 28 for replacing a light bulb. The opening 28 is open upwardly. The night light 20 includes a decorative globe 20 having an opening 32 open downwardly for replacing the night light bulb. In accordance with the respective wattages of the bulbs used in the fixture 10, the night light 20 is smaller than the main light 18. Preferably, the main light 18 uses a standard light bulb while the night light 20 uses a light bulb of reduced size and wattage.

The main light 18 and the night light 20 of the wall-mounted light fixture 10 may be independently illuminated or simultaneously illuminated in accordance with the desired effect for the space. In one embodiment of the invention, independent circuits 22 and 24 are provided to operate the lights 18 and 20. A wall switch 34, 36 associated with each circuit 22, 24 are independently operated to illuminate one or both of the main light 18 and the night light 20. As an alternative, a single circuit may be supplied to the light fixture 10 with a switch mounted on the fixture 10 itself used to cycle the fixture 10 through the various phases of illumination. In accordance with the present invention, the light fixture 10 may be utilized to provide the desired illumination both during waking hours and at night for comfort, security and safety.

The foregoing detailed description has been given for clearness of understanding only and no unnecessary limitations should be understood therefrom as some modifications will be obvious to those skilled in the art without departing from the scope and spirit of the appended claims.

What is claimed is:

1. A light fixture adapted to be mounted to a wall in electrical communication with an electrical circuit, said light fixture comprising:
a support structure extending from the wall;
a main light mounted to said support structure and connected to the electrical circuit for selective illumination to illuminate a living space; and
a secondary light mounted to said support structure and connected to the electrical circuit for selective illumination, said secondary light structurally separated from said main light, said main light and secondary light independently illuminable to provide varying degrees of illumination of the living space.

2. The light fixture as defined in claim 1 wherein said main light is disposed vertically above said secondary light.

3. The light fixture as defined in claim 2 wherein said main light extends upwardly from said support structure and said secondary light depends downwardly from said support structure.

4. The light fixture as defined in claim 3 wherein said support structure includes a support arm extending from a wall plate, said wall plate adapted to be mounted to the wall.

5. The light fixture as defined in claim 4 wherein said main light extends vertically upwardly from a remote outer end of said support arm and said secondary light extends vertically downwardly from said end of said support arm.

6. The light fixture as defined in claim 5 wherein said secondary light is lower in wattage than said main light to operate as a night light for specialized illumination.

7. The light fixture as defined in claim 6 wherein said main light and said secondary light are connected to independent electrical circuits for independent operation of the lights.

8. The light fixture as defined in claim 7 wherein said main light is larger than said secondary light.
